(19) United States
(12) Patent Application Publication
(10) Pub. No.: US 2006/0206923 A1
(43) Pub. Date: Sep. 14, 2006

(54) Method and system for self-encrypting key identification

(75) Inventor: Kevin W. Thompson, Sunnyvale, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Macrovision Corporation

(21) Appl. No.: 11/076,361

(22) Filed: Mar. 9, 2005

(51) Int. Cl. H04L 9/32

(52) U.S. Cl. 726/4

(57) ABSTRACT

A method and system for self-encrypting key identification are disclosed. In one embodiment, the method comprises receiving a first encryption ID from a first front-end server. The first front-end server includes a license manager. Subsequent encryption IDs are received from a plurality of front-end servers. The plurality of front-end servers including the first front-end server. The subsequent encryption IDs are compared with the first encryption ID. An error notification is generated when a subsequent encryption ID of the subsequent encryption IDs does not match the first encryption ID.

### FIELD OF THE INVENTION

The field of the invention relates generally to computer systems and more particularly relates to a method and system for self-encrypting key identification.

### BACKGROUND OF THE INVENTION

Generally, when software is sold, the purchaser is granted a license to use the software. Such a license imposes restrictions on the number of computers that can be used simultaneously, the term of use, the number of users allowed to use the software simultaneously in the case of a multi-user system, etc.

In recent years, however, illegal use of software beyond the restrictions imposed by license has become an object of public concern. For example, most software on the market permits only one computer to run the software, in a clause of the license. However, if the software has no illegal use prevention function incorporated therein, the software can readily be used on numerous computers.

Various techniques have therefore been developed to prevent illegal use of software. Some of such techniques use computer-specific identification information. Commercial software that is licensed using capacity-related metrics often includes or operates with validation systems that validate whether the software is running in environments which are compliant with current licensing terms and conditions. The commercial software may use a commercially available software application known in the art as a “license manager,” such as ISOGON'S IFOR or Macrovision's FLEX-LM, that uses a “license key” to unlock at least one component of the commercial software. Some electronic form of the license, typically, is evaluated and a license key is provided for the validation system to audit and control the commercial software in accordance with the commercial software licensing terms and conditions.

As license rules become more complex, the license managers must support these complex rules. For example, licenses may generate fees based upon usage (i.e., the number of hours a particular piece of software is used), or by the number of different users using the particular software per month. The complexity of rules coupled to the demands of enterprises growing internationally, require flexible license managers for efficient and accurate license fee calculations and billing.

### SUMMARY

A method and system for self-encrypting key identification are disclosed. In one embodiment, the method comprises receiving a first encryption ID from a first front-end server. The first front-end server includes a license manager. Subsequent encryption IDs are received from a plurality of front-end servers. The plurality of front-end servers includes the first front-end server. The subsequent encryption IDs are compared with the first encryption ID. An error notification is generated when a subsequent encryption does not match the first encryption ID.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIGS. 1-5 illustrate block diagrams of exemplary software license management systems, according to multiple embodiments of the present invention;

FIG. 6 illustrates, as an example, a block diagram of software modules and files residing on the front-end server, according to one embodiment of the present invention;

FIGS. 7A and 7B illustrate a flow diagram of an exemplary process of determining whether a common encryption key has been used by different computers to encrypt sensitive information, according to one embodiment of the present invention; and

FIG. 8 illustrates an exemplary computer architecture for use with the present system, according to one embodiment of the invention.

### DETAILED DESCRIPTION

A method and system for self-encrypting key identification are disclosed. In one embodiment, the method comprises receiving a first encryption ID from a first front-end server. The first front-end server includes a license manager. Subsequent encryption IDs are received from a plurality of front-end servers. The plurality of front-end servers including the first front-end server. The subsequent encryption IDs are compared with the first encryption ID. An error notification is generated when a subsequent encryption ID of the subsequent encryption IDs does not match the first encryption ID.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

As used herein, the following terms shall have the following meanings without regard to its upper or lower case usage.

“Back-end” refers to a server, computer or system under the control or otherwise authorized by a software Vendor to receive and process information received from a Customer of its usage of software licensed to the Customer by the Vendor.

“Customer” means a licensee of licensed software.

“File” refers to what is generally understood as a computer file, but as used here also includes any system for storing and retrieving digital data, inclusive of database managers, registries, directories and data objects.

“Front-end” refers to a server, computer or system under the control or otherwise authorized by a Customer to execute, manage and/or report usage of software licensed to the Customer.

“Server” means a computer process that other computer applications, operating systems, system software or compute services interact with. Within this definition, server as used in the terms “client-server”, “multi-tier computing”, “3-tier computing”, network services or web services are included.

“Vendor” means a licensor of licensed software including its copyright owner and other parties granted a right by the copyright owner to sell or otherwise distribute licenses to Customers to use the licensed software.

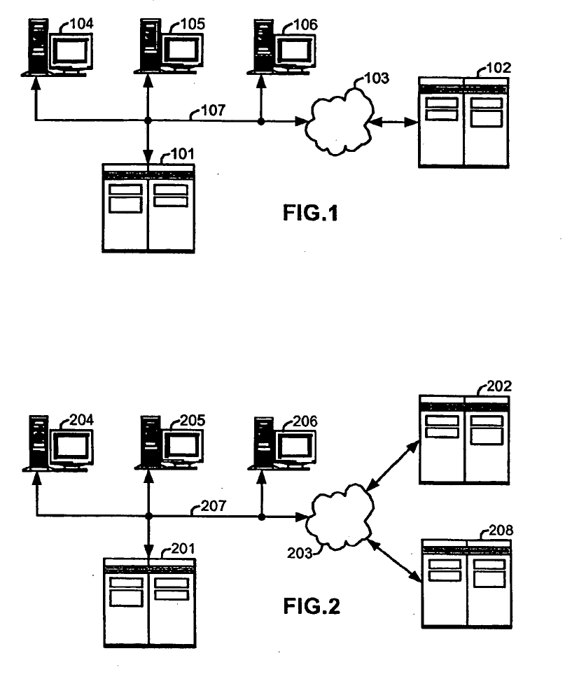

FIGS. 1-5 illustrate block diagrams of exemplary software license management systems, according to multiple embodiments of the present invention. In addition to these systems, it is to be appreciated that other systems employing the various teachings herein may also be used to practice the various aspects of the present invention, and as such, are considered to be within its full scope. It is also to be appreciated that proxy servers including firewalls may be conventionally inserted in these systems for security purposes, or to support other networking technologies, but are not shown nor described herein to simplify the following descriptions and such omissions are not to restrict the full scope of the present invention in any way.

In FIG. 1, a front-end server 101 is configurable to control usage of licensed software, generate an authenticatable report including information of such usage, and securely transmit the authenticatable report to a back-end server 102 corresponding to a designated destination, such as a direct dial-up telephone number, an Internet Uniform Resource Locator (URL), an email address or other networking address. The licensed software is distributed and operative on various front-end computers connected in a network 107, including the front-end server 101 and other computers represented as computers 104-106. The network 107 may be a Local Area Network (LAN), Wide Area Network (WAN), Virtual Private Network (VPN), or other network that is managed or otherwise controlled by a customer of the licensed software. Communication between the front-end server 101, which preferably resides at a location designated or authorized by the customer of the licensed software, and the back-end server 102, which preferably resides at a location designated or authorized by a vendor of the licensed software, is performed through a communication medium 103, such as the Internet, a private network or a direct dial-up connection. In the case of the Internet, secure transmission of an authenticatable report is preferably performed, for example, using the Secure Sockets Layer protocol (SSL), a Virtual Private Network (VPN), and/or encrypted email attachments.

Alternatively, any one or more of the front-end computers represented by front-end computers 104-106 on the network 107 may be configured, instead of or in addition to the front-end server 101, to control usage of its licensed software and/or the licensed software of other such computers, generate an authenticatable report including information of such usage, and securely transmit the authenticatable report to the back-end server 102. Accordingly, as used herein and in the following claims, the term “front-end server” is understood to also include such front-end computers when performing such functions. In addition to certain of the front-end computers being configured to run the licensed software, the front-end server 101 may also be so configured.

The back-end server 102 is configured to receive, authenticate, and process the authenticatable report to generate processed information, and provide the processed information to business operations software for post-use payment business model purposes and other uses. Examples of such business operations software include enterprise resource planning software (ERP), e-commerce software (such as those used for performing transactions over the Internet), customer relationship management software (CRM), and sales force automation software (SFA).

FIG. 2 shows a variation of a software license management system, wherein the authenticatable report may be transmitted to more than just one back-end server for processing. In this example, back-end servers 202 and 208 may redundantly receive the same authenticatable report or alternatively, may cooperate to process an authenticatable report by splitting up such processing activity, while computers represented by front-end computers 204-206, front-end server 201, network 207, and communication media 203 preferably function as their respective counterparts in FIG. 1.

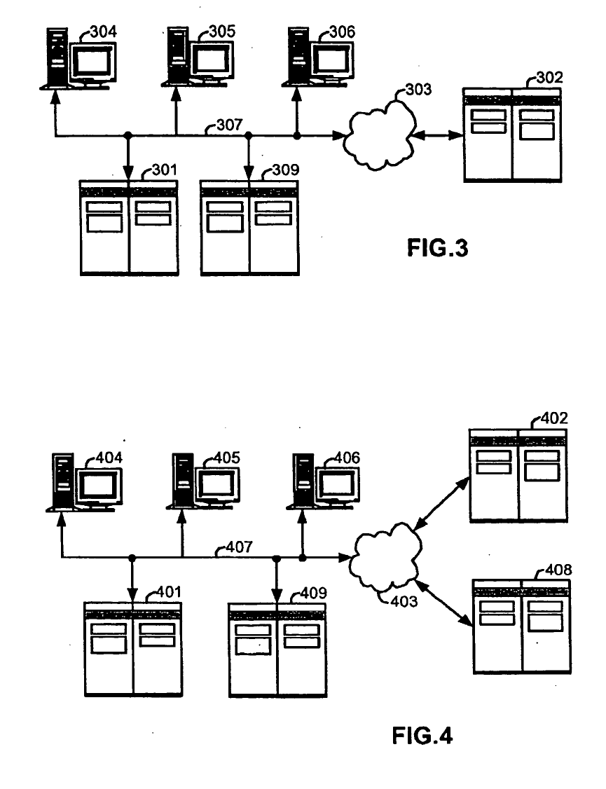

FIG. 3 shows another variation of a software license management system, wherein more than one front-end server securely transmits an authenticatable report to a back-end server 302. In this example, front-end servers 301 and 309 may be redundant servers, providing the same authenticatable report to the back-end server 302, or they may be independent servers, providing different authenticatable reports to the back-end server 302. In the case where redundant front-end servers are used, successful transmission of the authenticatable report is reasonably ensured even when one of the front-end servers goes “down” (i.e., becomes inoperative). After the “down” front-end server comes back “up”, then it is “synchronized” with the other front-end server so that they both store the same information (e.g., in their respective report logs), and such information is never “lost” as a result of one of the redundant front-end servers going “down”. In the case where independent servers are used, report log and/or report generation responsibilities may be split up between the two front-end servers 301 and 309. One example of this latter case is where each of the front-end servers reports usage for a different division or profit center of the customer. In either the redundant or independent front-end server cases, front-end computers 304-306, network 307, communication media 303, and back-end server 302 preferably function as their respective counterparts in FIG. 1.

FIG. 4 shows another variation of a software license management system, wherein more than one front-end server securely transmits one or more transfer files to more than one back-end server. In this example, front-end computers 404-406 preferably function as their counterparts in FIG. 1, network 407 and front-end servers 401 and 409 preferably function as their respective counterparts in FIG. 3, and communication medium 403 and back-end servers 402 and 408 preferably function as their respective counterparts in FIG. 2.

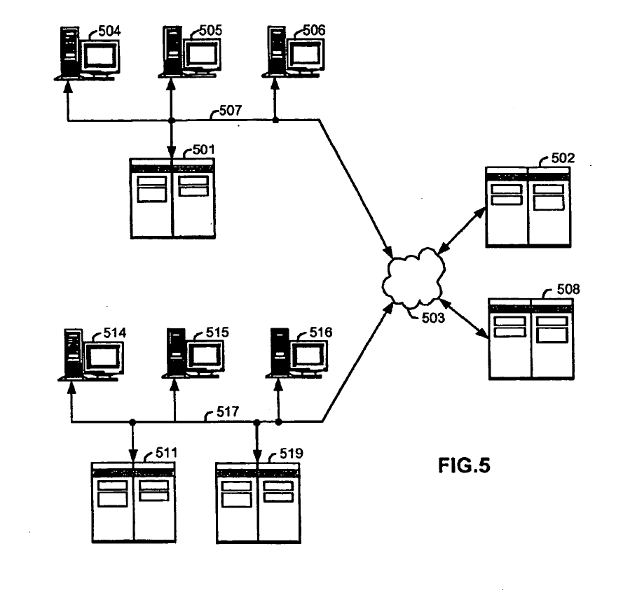

FIG. 5 shows yet another variation of a software license management system, wherein more than one network is used by a customer. In this example, a first network 507 connects a first front-end server 501 and representative front-end computers 504-506 to communicate with one another and to one or both back-end servers 502 and 508 through a communication medium 503, all of which preferably function as their respective counterparts in FIG. 2; and a second network 517 connects second and third front-end servers 511 and 519, and representative front-end computers 514-516 to communicate with one another and to one or both back-end servers 502 and 508 through the communication medium 503, all of which preferably function as their respective counterparts in FIG. 4. The different networks may be used by different subsidiaries or divisions of a customer.

In the example of FIG. 5 front-end computers 504-506, 514-515 running a particular application or program send messages to a license manager resident on front-end servers 501, 511, 519 to see if use of the application is permitted. The license manager in the front-end servers 501, 511, 519 collect this type of usage data and report it to the back-end servers 502, 508. With the usage data, back-end server 502, 508 can determine how much a customer should be billed for use of the licensed application or program. For example, a vendor may bill customers based on the number of employees/users the customer has using the licensed program per month.

This scenario may be problematic for systems such as the example of FIG. 5 where there are multiple front-end servers 501, 511, 519. As companies (customers) expand in size and geographically, it is conceivable that multiple front-end servers 501, 511, 519 will be used. Continuing with the above-example, if an employee (user) requires use of a license manager in front-end server 501, and then uses a second front-end server 511 (in the same billing period), the customer (company) may be billed twice by the software vendor who is unaware that the same employee utilized two different front-end servers 501, 511. This inaccuracy in billing will be explained in greater detail below.

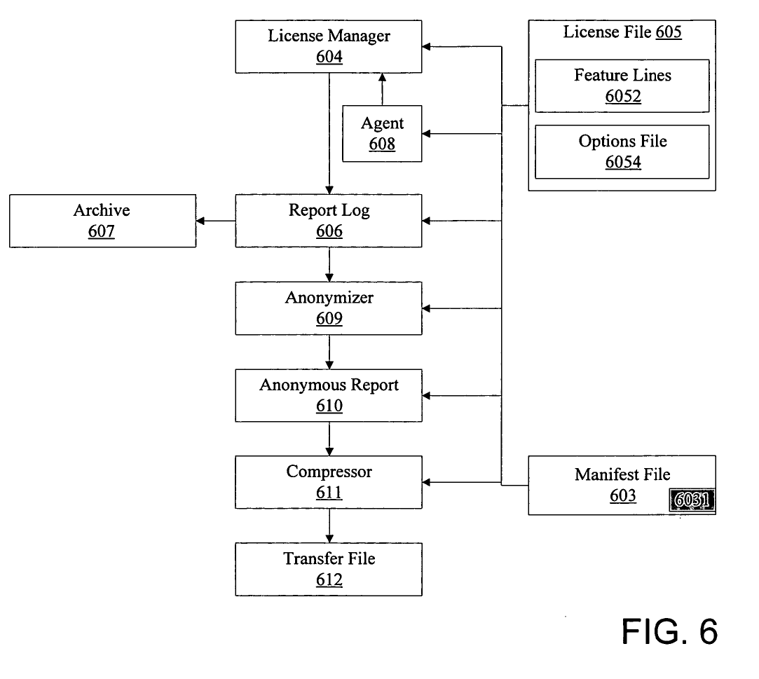

FIG. 6 illustrates, as an example, a block diagram of software modules and files residing on the front-end server 101 that serve to configure the front-end server 101 to perform the functions described above in reference to FIG. 1. Although information is shown as being stored in files in this example, it is to be appreciated that the information could also be stored in a registry, such as the Microsoft Windows Registry or even a network-wide system directory such as LDAP, or other similar systems used to store data. Where other front-end servers or front-end computers such as those described in reference to FIGS. 1-5 also or alternatively perform these functions, it is to be understood that corresponding copies of the following described software modules and files also reside on or are at least available to those servers or computers. A license file 605 includes feature lines 6052 which describe the license terms for licensed software. Alternatively, instead of lines in a license file, such data may be stored as tagged data describing their respective license terms in a different file format, or as data within a database scheme or registry. A license manager 604 controls usage of the licensed software according to the license terms 6052, and generates, as appropriate, a report log 606 of such usage. This report log 606 is anonymized and packaged with a manifest file 603 by the anonymizer 609 and file compressor 611, and sent as a transfer file 612 from customer front-end servers 501, 511, 519 to vendor back-end servers 502, 208.

Each of the schedule-file lines in 605 provides information for transfer files 612 that are to be generated by the anonymizer 609 and file compressor 611, and each of the feature lines 6052 provides licensing information for the features of the licensed software. Generally, there are multiple features in a licensed software product, and sometimes, one feature may spread across multiple licensed software products. Separation of report schedule and feature lines allows multiple feature lines to be indexed to the same report schedule line. For example, different business units of a vendor identified in different feature lines can receive feature usage reports that are identically formatted for its particular products. Alternatively, usages of the same features may be reported in different or unique ways for the different business units.

An agent, service or daemon (hereinafter simply referred to as an “agent”) 608 running as a background process on the front-end server 101 serves as a scheduler to notify the license manager 604 that it is time to rotate (archive to a new location) the existing report log 606, producing an archived report log 607. The license manager then continues recording new usage information to a new report log 606. The agent 608 then executes the anonymizer 609 on the archived report log 607 to produce an anonymized report log 610, and executes the file compressor 611 to compresses the anonymized report log 610, together with a manifest file 603, into a transfer file 612. The agent 608 reads a scheduled time for such action from schedule information in its schedule file (which is an XML file that is separate from any license file; remove 6051). The transmission of the transfer file 612 to a back-end server 502, 508 is automated.

The agent 608 performs additional functions involving report log 606. First, agent 608 rotates the report log 606. That is, at a scheduled time agent 608 coordinates the archiving of a current report log 606 to a particular directory/location with a specified name 607. After archival, the agent 608 then commences generation of a new report log 606.

Secondly, agent 608 anonymizes the report log 607. The anonymization process includes modifying the file extension of report log 607(i.e., log.rl become log.arl). Additionally, anonymization includes replacing and/or removing sensitive information from the report log 607, such as individual user names to produce the anonymized report log 610. The sensitive names are replaced by encrypted character strings that are generated with a private key residing in agent 608.

Thirdly, agent 608 compresses the anonymized report log 610 (i.e., into a.zip file, called a “transfer file” 612). A manifest file 603 (described in detail below) is created to accompany the anonymized report log 610 in the transfer file 612, after which the transfer file 612 is sent to back-end server 502, 508. The manifest file 603 and the anonymized report log 610 are packaged into a transfer file 612 and sent to back-end server 502, 508 for example, using e-mail.

Although the agent 608 may be a separate module as shown in FIG. 6, preferably it is a part of the license manager 604 that is always running.

A schedule file 602 indicates to the anonymizer 609 the format and data filtering parameters needed to generate the anonymized report log 610 and the manifest file 603. The manifest file 603 includes an encryption ID 6031 that provides an indication of the encryption key used by agent 608, without divulging what the actual encryption key is. Also included in the manifest file is information such as the date, and host name information (i.e., the front-end server 501, 511, 519).

Typically a customer (company) will have multiple license servers such as front-end servers 501, 511, 519. The front-end servers 501, 511, 519 will host agents 608 from multiple vendors implementing different access control mechanisms for each program or application it controls. As mentioned above, an employee (user) might log into a front-end server 501 one day in California. The next day, the same employee (user) might log into a different front-end server 511 that is in Hong Kong. Both front-end servers 501, 511 using their respective agents 608 generate report logs 606. The employee (user) information included in the report logs 606 is anonymized by replacing the employee (user) identification information with a string of characters (i.e., an encrypted version of the employee (user) identification information).

If the agent 608 of front-end server 501 is using a different encryption key than the agent 608 of front-end server 511, then the employee (user) will appear to be two different users. If billing is based on the number of users, an inaccurate bill will result. Thus, to ensure accurate billing, all of a customer's front-end servers 501, 511, 519 should implement a common encryption key with agents 608.

A vendor can not control the front-end servers 501, 511, 519 to ensure the customer uses a common encryption key. Additionally, the customer will not send the encryption key of each agent 608 to the vendor for comparison, as such an act will compromise the security of the sensitive information protected through the anonymization process. Thus, according to one embodiment of the present method and system the vendor's back-end servers 502, 508 can detect when the customer's front-end servers 501, 511, 519 use different encryption keys through encryption ID 6031. Encryption ID 6031 indicates to the vendor's back-end servers 502, 508 if a particular encryption key has been used without revealing the encryption key value itself.

Encryption ID 6031 can take on any value that indicates if a particular encryption key has been used without revealing the encryption key value itself. However, according to one embodiment of the present invention, encryption ID 6031 is a value equal to the encryption key after being encrypted with itself, that is a self-encrypted key identification. In alternate embodiments, although it is less secure than using the encryption key itself, a plain text string may be used to encrypt the encryption key. Generating an encryption ID 6031 using a text string is feasible when the text string is maintained secret from the vendor, so the vendor can not determine the encryption key and then decipher the sensitive information with it. In yet another embodiment, the front-end servers 501, 511, 519 exchange encryption ID 6031 information (encrypted or unencrypted) to identify if different encryption keys are not used.

By using a self-encrypted key ID as encryption ID 6031, certain security advantages are attained, including prevention of reverse engineering, generation of a unique and consistent result, and protection of the actual encryption key.

Upon receipt of a transfer file 612, a receiver module that resides on back-end servers 502, 508 extracts the anonymized report log 610 and manifest file 603. Back-end servers 502, 508 decompress the transfer file 612 and stores the transmitted copy of the anonymized report log 610 in its file system. Additionally, back-end servers 502, 508 store the encryption ID 6031 associated with the anonymized report log 610 in the local database. Once new transfer files 612 are received, back-end servers 502, 508 compare the stored encryption ID with the encryption IDs 6031 received in the new transfer files 612 from the front-end servers 501, 511, 519. If the stored encryption ID does not match a newly received encryption ID 6031, an error message is generated and sent to an administrator. The error message indicates that a particular agent 608 does not have the same encryption key as has previously been used by the customer. The administrator can then take an appropriate action of notifying the customer, such that the customer can correct the problem and insure accurate billing of license fees.

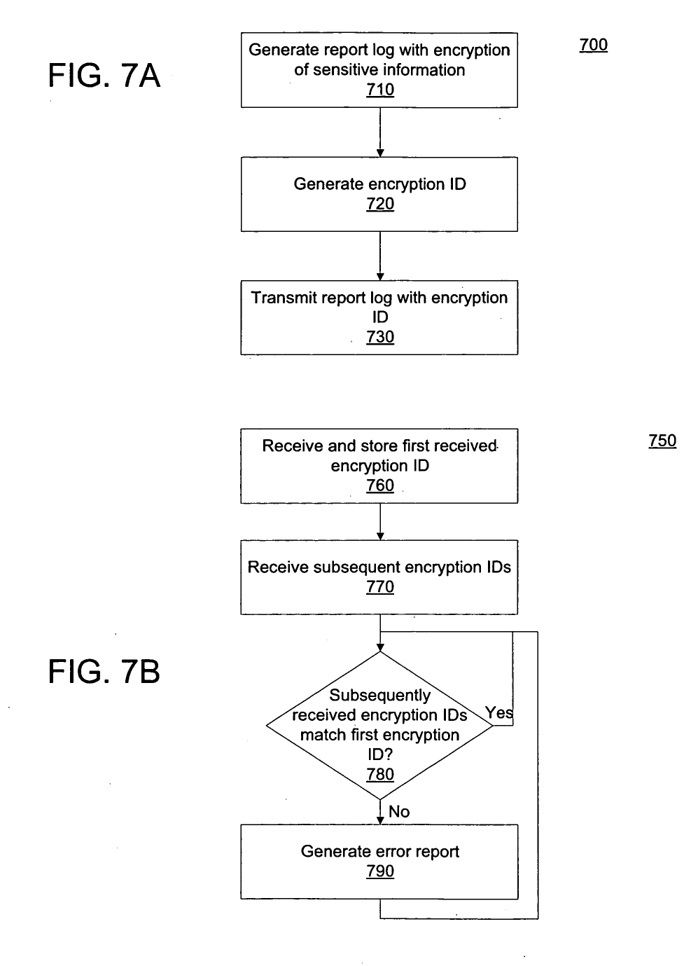

FIGS. 7A and 7B illustrate a flow diagram of an exemplary process of determining whether a common encryption key has been used by different computers to encrypt sensitive information, according to one embodiment of the present invention. FIG. 7A illustrates the flow diagram of an exemplary front-end server process 700, according to one embodiment of the present invention. Agent 608 generates a report log 606 that is anonymized. (710) Anonymization involves encryption of sensitive information with a private key. Agent 608 generates an encryption ID 6031 that indicates if a common encryption key has been used by multiple front-end servers to encrypt sensitive information, without revealing the encryption key itself. (720) The agent 608 transmits the anonymized report log 610 with the encryption ID 6031 provided in the manifest file 603. The anonymized report log 610 is then combined with manifest file 603 to generate a transfer file 612 that is transmitted to a back-end server.

FIG. 7B illustrates the flow diagram of an exemplary back-end server process 750, according to one embodiment of the present invention. Upon installation of the system, the back-end server receives an anonymized report log 610 and stores the first encryption ID 6031. (760) More particularly, a back-end server may receive a transfer file 612, separate the transfer file 612 into an anonymized report log 610 and manifest file 603. Additionally, the back-end server may decompress the anonymized report log 610 and extract the encryption ID 6031 from the manifest file 603. As additional agents in different front-end servers generate report logs and transmit them to the back-end server(s), subsequent encryption IDs are received with the report logs. (770) Back-end servers compare the subsequently received encryption IDs with the stored encryption ID to determine if they match. (780) If there is no match, an error report is generated by the back-end server which may be forwarded to an administrator. The error report identifies the agent 608 that did not have a matching encryption ID. If the stored encryption ID and the subsequently received encryption ID match, the process continues to compare subsequently received encryption IDs without generating an error report.

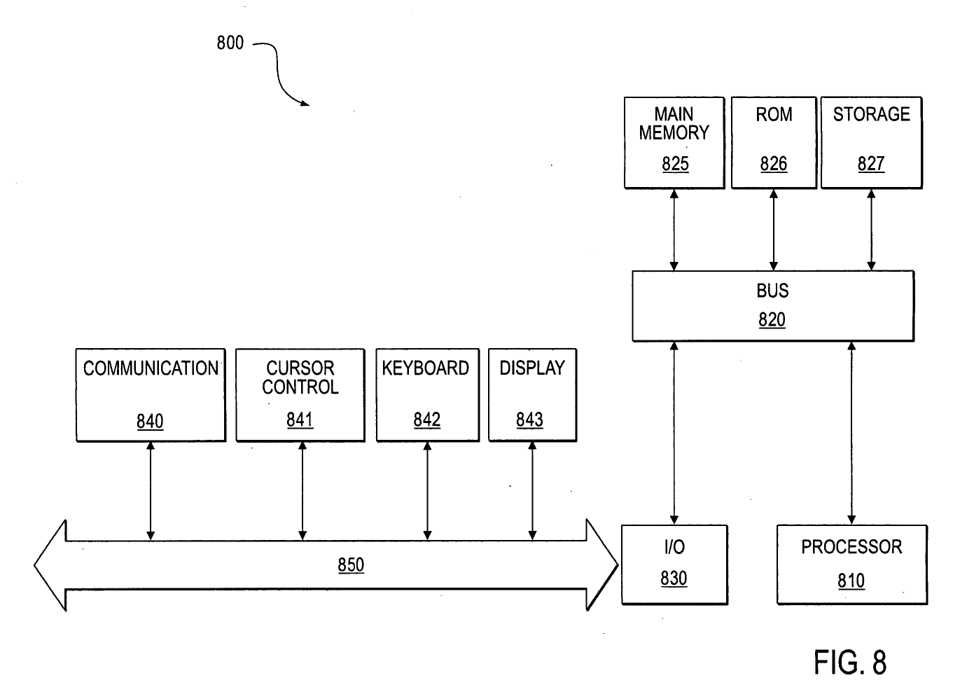

FIG. 8 illustrates an exemplary computer architecture for use with the present system, according to one embodiment of the invention. Computer architecture 800 can be used to implement both front-end computers 104-106, front-end servers 101, and back-end servers 102 of FIG. 1 (and their respective equivalents in FIGS. 2-5). One embodiment of architecture 800 comprises a system bus 820 for communicating information, and a processor 810 coupled to bus 820 for processing information. Architecture 800 further comprises a random access memory (RAM) or other dynamic storage device 825 (referred to herein as main memory), coupled to bus 820 for storing information and instructions to be executed by processor 810. Main memory 825 also may be used for storing temporary variables or other intermediate information during execution of instructions by processor 810. Architecture 800 also may include a read only memory (ROM) and/or other static storage device 826 coupled to bus 820 for storing static information and instructions used by processor 810.

A data storage device 827 such as a magnetic disk or optical disc and its corresponding drive may also be coupled to computer system 800 for storing information and instructions. Architecture 800 can also be coupled to a second I/O bus 850 via an I/O interface 830. A plurality of I/O devices may be coupled to I/O bus 850, including a display device 843, an input device (e.g., an alphanumeric input device 842 and/or a cursor control device 841). For example, web pages and business related information may be presented to the user on the display device 843.

The communication device 840 is for accessing other computers (servers or clients) via a network. The communication device 840 may comprise a modem, a network interface card, a wireless network interface or other well known interface device, such as those used for coupling to Ethernet, token ring, or other types of networks.

Although the present method and system have been described with respect to a license management system, one of ordinary skill would understand that the techniques described may be used in any situation where knowledge is needed as to whether a common encryption key has been used to encrypt sensitive information, without revealing the encryption key itself. For example, the encryption ID of the present method and system may be implemented in financial data systems, secure message transmissions, and similar secure systems.

A method and system for self-encrypting key identification has been disclosed. Although the optimized interface has been described with respect to specific examples and subsystems, it will be apparent to those of ordinary skill in the art that it is not limited to these specific examples or subsystems but extends to other embodiments as well.

I claim:

1 . A computer-implemented method, comprising:
receiving a first encryption ID from a first front-end server, wherein the first front-end server includes a license manager;
receiving subsequent encryption IDs from a plurality of front-end servers, the plurality of front-end servers including the first front-end server;
comparing the subsequent encryption IDs with the first encryption ID; and
generating an error notification when a subsequent encryption ID of the subsequent encryption IDs does not match the first encryption ID.

2. The computer-implemented method of claim 1, wherein the first encryption ID is a self-encrypted key identification.

3. The computer-implemented method of claim 1, wherein the first encryption ID is encrypted with a textual string.

4. The computer-implemented method of claim 1, wherein comparison of the first encryption ID and the subsequent encryption IDs determines whether a common encryption key has been used to generate encrypted information, without revealing the common encryption key itself.

5. The computer implemented method of claim 4, wherein the first encryption ID is included in a manifest file, the encrypted information is included in a report log, and the manifest file and report log are combined into a transfer file that is received by a back-end server.

6. The computer implemented method of claim 1, wherein the error notification indicates that a common encryption key has not been used by the plurality of front-end servers to generate encrypted information.

7. A computer-readable medium having stored thereon a plurality of instructions, said plurality of instructions when executed by a computer, cause said computer to perform:
receiving a first encryption ID from a first front-end server, wherein the first front-end server includes a license manager;
receiving subsequent encryption IDs from a plurality of front-end servers, the plurality of front-end servers including the first front-end server;
comparing the subsequent encryption IDs with the first encryption ID; and
generating an error notification when a subsequent encryption ID of the subsequent encryption IDs does not match the first encryption ID.

8. The computer-readable medium of claim 7, wherein the first encryption ID is a self-encrypted key identification.

9. The computer-readable medium of claim 7, wherein the first encryption ID is encrypted with a textual string.

10. The computer-readable medium of claim 7, wherein comparison of the first encryption ID and the subsequent encryption IDs determines whether a common encryption key has been used to generate encrypted information, without revealing the common encryption key itself.

11. The computer-readable medium of claim 10, wherein the first encryption ID is included in a manifest file, the encrypted information is included in a report log, and the manifest file and report log are combined into a transfer file that is received by a back-end server.

12. The computer-readable medium of claim 7, wherein the error notification indicates that a common encryption key has not been used by the plurality of front-end servers to generate encrypted information.

13. A computer system, comprising:
a processor; and
memory coupled to the processor, the memory storing instructions;
wherein the instructions when executed by the processor cause the processor to, receive a first encryption ID from a first front-end server, wherein the first front-end server includes a license manager;
receive subsequent encryption IDs from a plurality of front-end servers, the plurality of front-end servers including the first front-end server;
compare the subsequent encryption IDs with the first encryption ID; and
generate an error notification when a subsequent encryption ID of the subsequent encryption IDs does not match the first encryption ID.

14. The computer system of claim 13, wherein the first encryption ID is a self-encrypted key identification.

15. The computer system of claim 13, wherein the first encryption ID is encrypted with a textual string.

16. The computer system of claim 13, wherein comparison of the first encryption ID and the subsequent encryption IDs determines whether a common encryption key has been used to generate encrypted information, without revealing the common encryption key itself.

17. The computer system of claim 16, wherein the first encryption ID is included in a manifest file, the encrypted information is included in a report log, and the manifest file and report log are combined into a transfer file that is received by a back-end server.

18. The computer system of claim 13, wherein the error notification indicates that a common encryption key has not been used by the plurality of front-end servers to generate encrypted information.
